(19) United States
(12) Patent Application Publication
(10) Pub. No.: US 2021/0248883 A1
(43) Pub. Date: Aug. 12, 2021

(54) Methods and Apparatus for Indicating Evacuation Routes

(71) Applicant: Arm IP Limited, Cambridge (GB)

(72) Inventor: Sean Tristram LeGuay Ellis, Farnham (GB)

(73) Assignee: Arm IP Limited, Cambridge (GB)

(21) Appl. No.: 16/973,345

(22) PCT Filed: Jun. 7, 2019
(86) PCT No.: PCT/GB2019/051601

§ 371 Date: Dec. 8, 2020

(30) Foreign Application Priority Data
Jun. 11, 2018 (GB) 1809533.1

(51) Int. Cl. G08B 7/06; G08B 17/00; G08B 21/02; G01C 21/20

(52) U.S. Cl. CPC G08B 7/066; G08B 7/062; G01C 21/206; G08B 21/02; G08B 17/00

(57) ABSTRACT

A plurality electronic alarms may be provided, which when activated, indicate a route to at least one exit. A plurality may be one electronic alarm, and the alarms may emit an audible sound, such as a voice informing people within the building of a distance/direction to an exit. A plurality may be one or more electronic alarms, and when more than one alarm is provided, each alarm may generate a different audible sound, such that a person can determine a direction in which to travel to exit the building. The sound emitted from different alarms may differ in pitch or frequency of modulation. In addition, the sound emitted from different alarms may be sequenced in the direction of travel. In addition, or alternatively, the plurality of alarms may produce visual cues indicating the direction in which to travel to exit the building. The visual cues may also be sequenced in the direction of travel.

The present techniques relate to apparatus and methods for providing exit route indications during an emergency situation. More particularly, the techniques relate to using a plurality of audible and/or visible indications to direct users to exits during an emergency situation.

When an emergency situation, such as a fire within a building, occurs conventional alarm systems may be trigged by sensors detecting the fire, for example heat and/or smoke detectors, or may be trigged by a user manually activating an alarm. Once activated a loud audible warning noise is made, either continuously or periodically to indicate to people within the building, that a fire has been detected and that they should evacuate the building.

However, people within the building may not be aware of the route to an exit from the building and/or visibility may be reduced, as a result of smoke from the fire, hampering attempts to exit the building. In addition, some people within the building may be hearing impaired so may not be able hear conventional exit alarms, or visually impaired so may not be able to see conventional exit signs. Furthermore, some exits may be more desirable then others as a result of the location of the fire, however, people within the building may not be aware of this. For example, a conventional exit sign may direct people toward the fire, when the fire originated on the route to the exit, since the exit alarm has no knowledge of whether or not a particular route to an exit is desirable.

According to a first technique, there is provided a method for indicating at least one emergency escape route. The method comprising: activating, in response to receiving an emergency situation signal indicative of an emergency situation, an emergency alarm system comprising a plurality of electronic alarms; and wherein, following activation, the plurality of electronic alarms indicate a determined viable route to an exit, the viable route determined based on environmental data.

According to a second technique, there is provided a computer readable storage medium comprising program code for performing the methods described herein.

According to a third technique, there is provided an emergency alarm system for indicating at least one emergency escape route. The emergency alarm system comprising: a plurality of electronic alarms, wherein the plurality of electronic alarms are configured to be activated in response to receiving an emergency situation signal indicative of an emergency situation; and wherein, following activation, the plurality of electronic alarms indicate a determined viable route to an exit, the viable route being determined based on environmental data.

According to a fourth technique, there is provided an emergency alarm for use in an emergency alarm system. The emergency alarm comprising: an emitter configured to indicate a determined viable route to an exit in response to receiving an emergency situation signal indicative of an emergency situation, wherein the viable route to the exit is determined based on environmental data; and a processor configured to modify the indication to be emitted by the emergency alarm in response to a re-determination of the viable route to the exit.

Embodiments will now be described with reference to the accompanying figures of which:

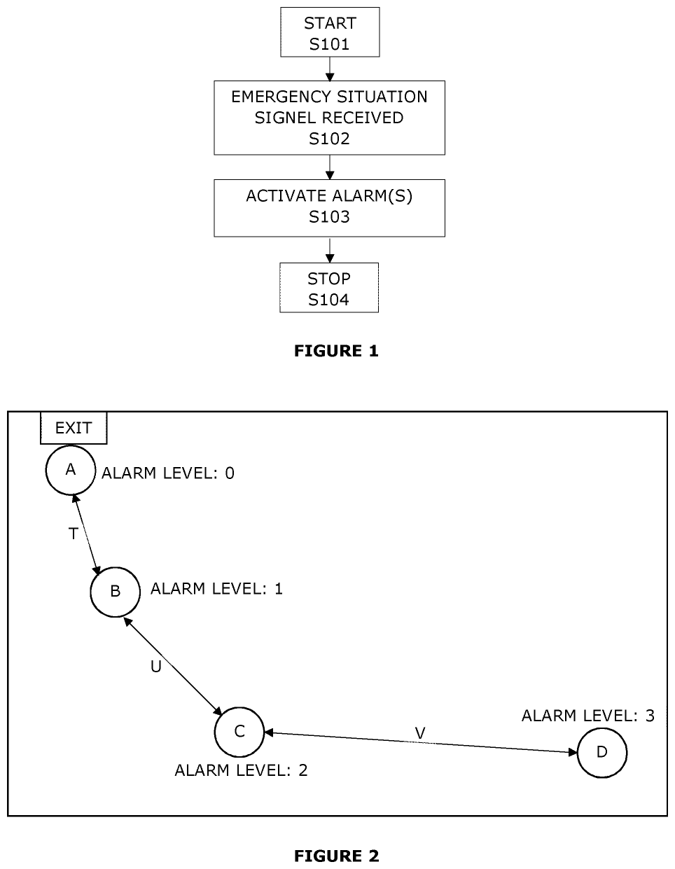

FIG. 1 illustrates a flow diagram of a method of activating emergency alarms;

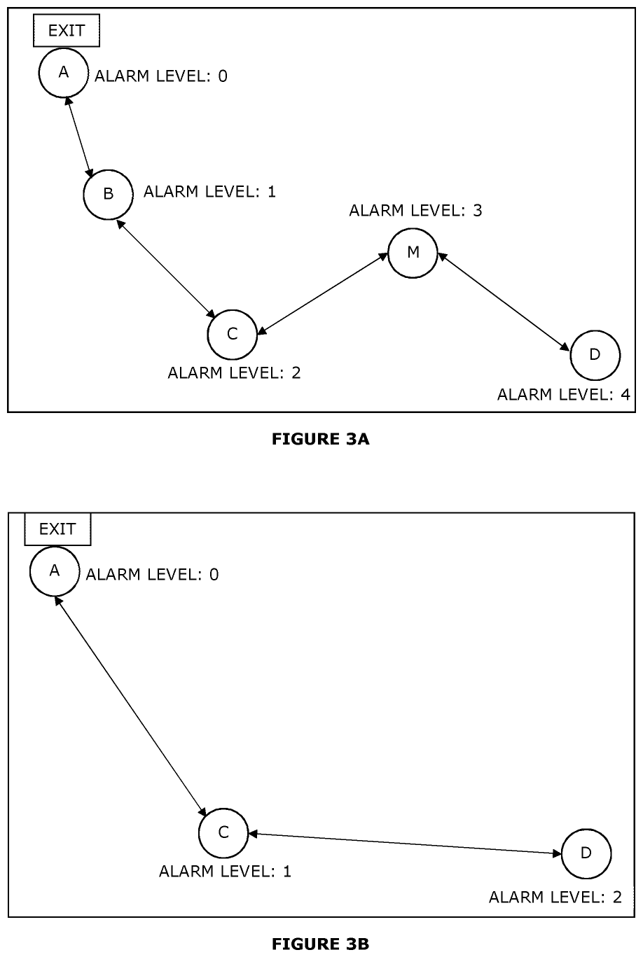

FIG. 2 illustrates schematically an arrangement of a plurality of emergency alarms;

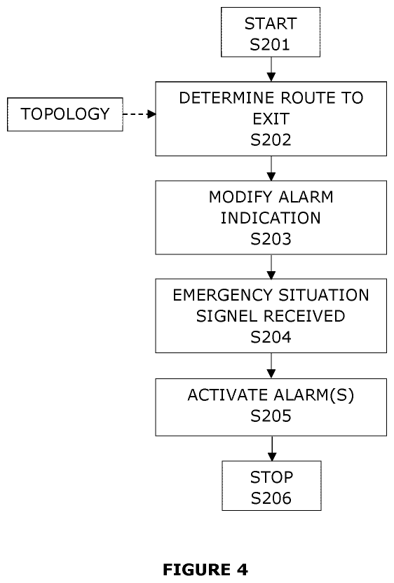

FIG. 3A illustrates schematically another arrangement of a plurality of emergency alarms;

FIG. 3B illustrates schematically another arrangement of a plurality of emergency alarms;

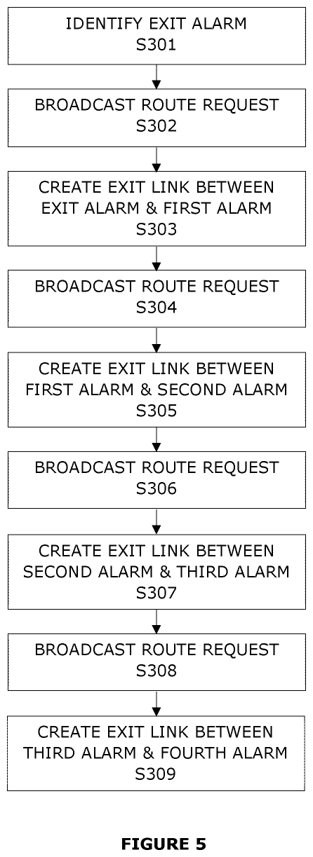

FIG. 4 illustrates a flow diagram of a method of activating emergency alarms;

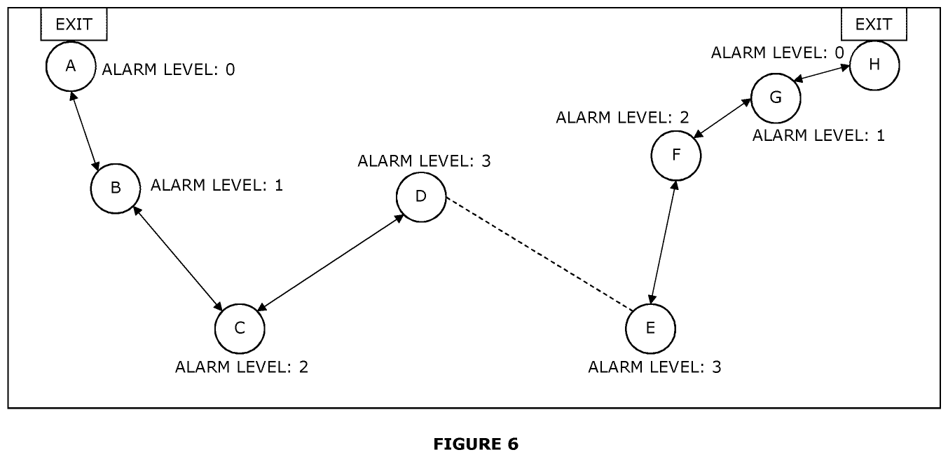

FIG. 5 illustrates a flow diagram of a method of determining a route to an exit;

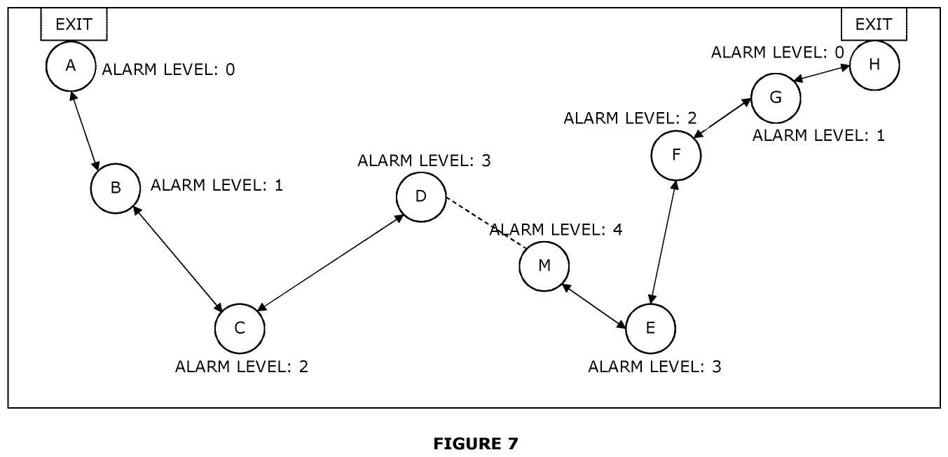

FIG. 6 illustrates schematically another arrangement of a plurality of emergency alarms;

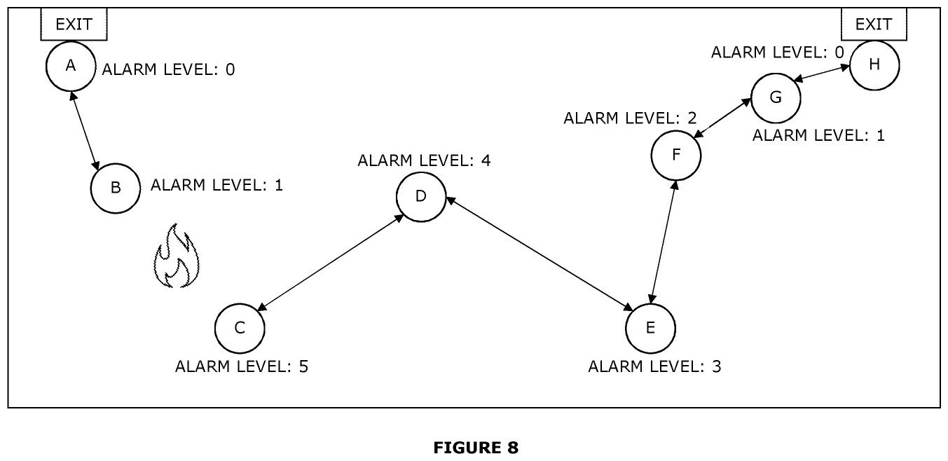

FIG. 7 illustrates schematically another arrangement of a plurality of emergency alarms;

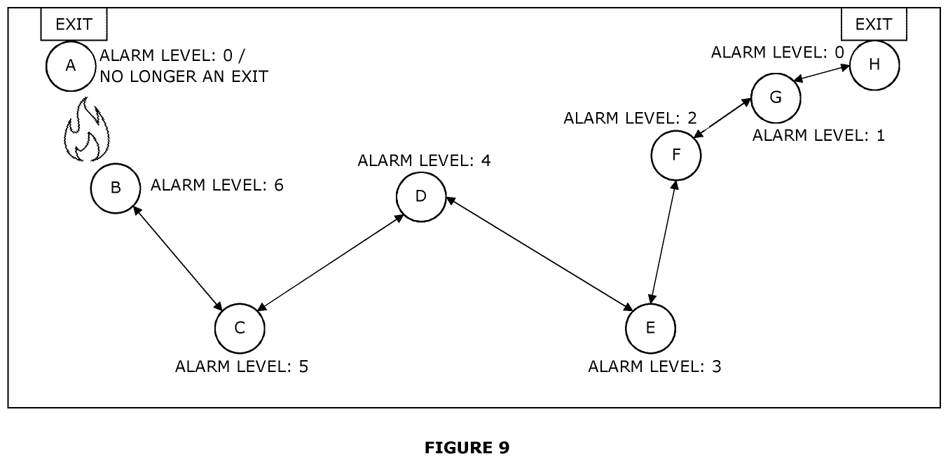

FIG. 8 illustrates schematically another arrangement of a plurality of emergency alarms; and

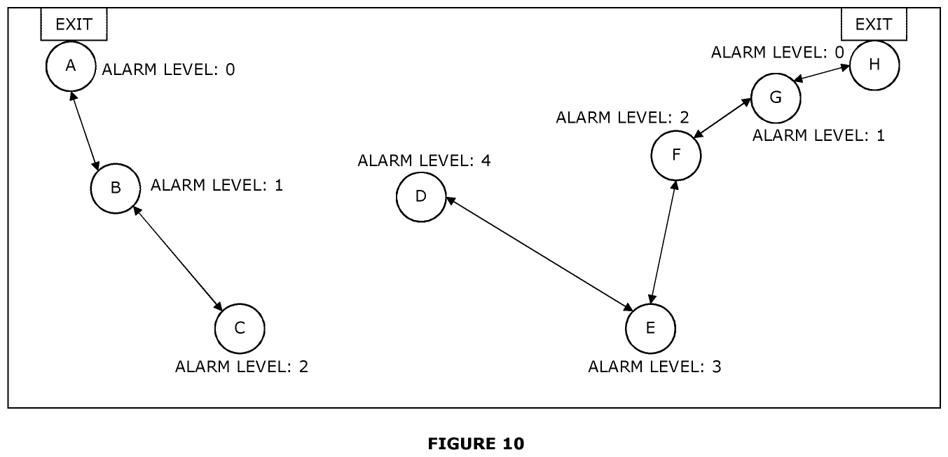

FIG. 9 illustrates schematically another arrangement of a plurality of emergency alarms; and

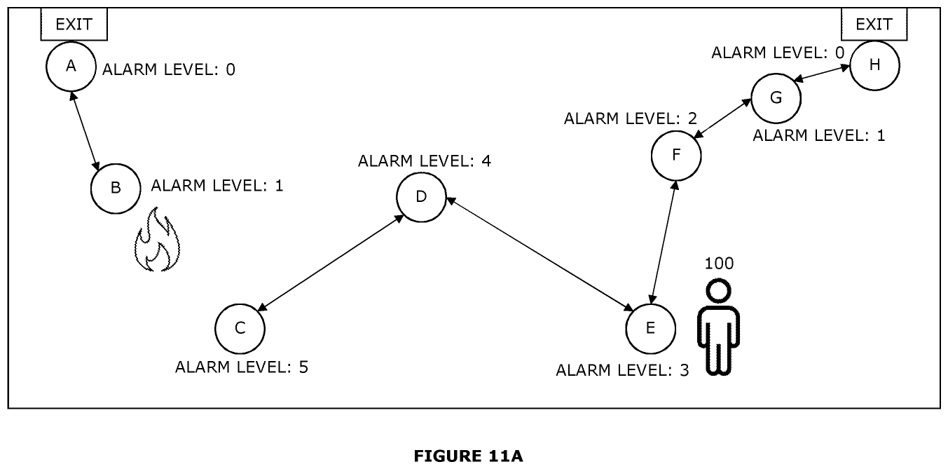

FIG. 10 illustrates schematically another arrangement of a plurality of emergency alarms;

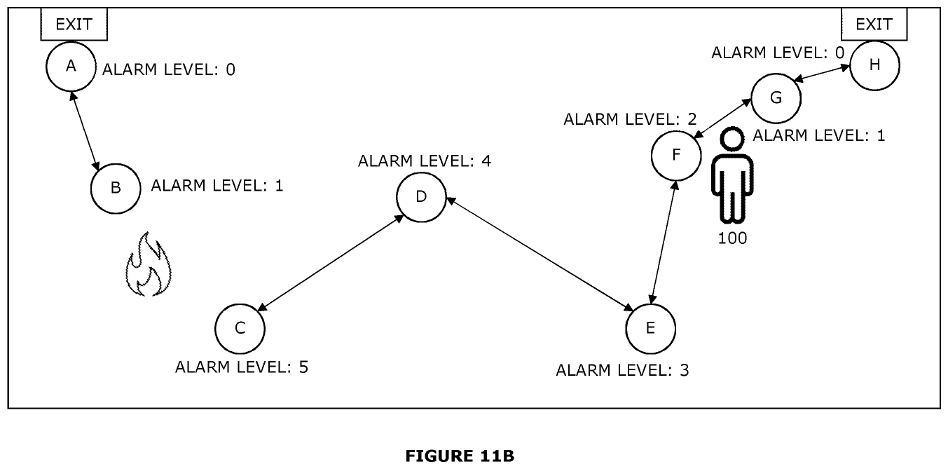

FIG. 11A illustrates schematically another arrangement of a plurality of emergency alarms;

FIG. 11B illustrates schematically another arrangement of a plurality of emergency alarms; and

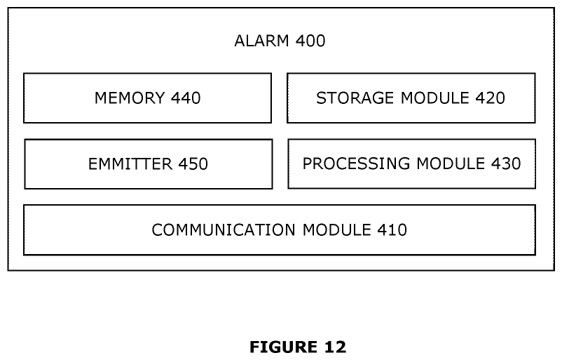

FIG. 12 illustrates schematically an emergency alarm of the emergency alarm system.

A plurality electronic alarms may be provided, which when activated, indicate a route to at least one exit. A plurality may be one electronic alarm, and the alarm may emit an audible sound, such as a voice informing people within the building of a distance/direction to an exit. A plurality may be one or more electronic alarms, and when more than one alarm is provided, each alarm may generate a different audible sound, such that a person can determine a direction in which to travel to exit the building. The sound emitted from different alarms may differ in pitch, tone or frequency of modulation. In addition, the sound emitted from different alarms may be sequenced in the direction of travel. In addition, or alternatively, the alarms may produce visual cues indicating the direction in which to travel to exit the building. The visual cues may also be sequenced in the direction of travel.

Reference will now be made in detail to the embodiments, examples of which are illustrated in the accompanying drawings. In the following detailed description numerous specific details are set forth by way of examples in order to provide a thorough understanding of the relevant teachings. However, it will be apparent to one of ordinary skill in the art that the present teachings may be practiced without these specific details.

In other instances, well known methods and/or components have been described at a relatively high-level, without detail, in order to avoid unnecessarily obscuring aspects of the present teachings.

An emergency alarm system comprises at least one electronic alarm, which, when activated, indicates a viable route to an exit and/or a proximity to the exit. Each electronic alarm is able to perform wireless communication with other elements of the system. According to one embodiment, the alarm may produce an audible indication, such as a voice informing people within the building of a direction to and/or a distance to an exit. Alternatively, or in addition, the alarm may produce a visual indication, such as a visual display informing people within the building of a direction to and/or a distance to an exit.

A viable route to an exit is considered to be a route to an exit that a person could/should take. For example, there may be multiple routes to an exit, however, the viable route may be a route which is the most direct route to the exit. Alternatively, or in addition, there may be multiple exits, however one or more of the exits may not be operable, therefore, a route to a non-operable exit is no longer considered a viable exit route. Moreover, when a location of an emergency situation, such as a fire, is known, which is on a route to an exit, then that route may no longer be considered a viable route since it takes a user towards the emergency situation. Furthermore, the emergency alarm system is able to re-determine a route to the exit and to modify the alarm indication emitted by each alarm in response to the re-determined route and/or information it receives from a wider network. Consequently, the viable route to the exit is not necessarily a fixed route but is instead determined in response to environmental data obtained from the elements of the emergency alarm system and may be changed in response to the received data.

FIG. 1 illustrates a flow diagram of a method of activating an emergency alarm system. As illustrated in FIG. 1, the process starts at step S101. At step S102, an emergency situation signal is received at the emergency alarm system. When an emergency situation is detected, for example, by a smoke alarm detecting smoke, a heat detector detecting heat, a user activating a manual alarm button etc., an emergency situation signal is sent to the emergency alarm system. The at least one alarm is then activated at step S103. The alarm(s) will continue to be active until the system is stopped, at step S104, for example, by a user when it is determined that the alarm is no longer required to be active.

The emergency alarm system may comprise more than one electronic alarm, which, when activated, work together to indicate a route to an exit. Each alarm, when activated, may produce an indication as to the direction of travel a person should take in order to reach an exit. The indication produced at each alarm may differ from the indication produced at other nearby alarms. According to one embodiment, the tone/pitch of an audible indication produced at each alarm may be different from the tone/pitch of an audible indication produced at other nearby alarms. According to another embodiment, the frequency of modulation of an audible indication produced at each alarm may be different from the frequency of modulation of an audible indication produced at other nearby alarms. The audible indication produced at each alarm is not limited to differing in tone/pitch or frequency of modulation from the audible indication produced at other alarms and may differ in other respects.

The tone/pitch and/or the frequency of modulation of an audible indication produced at each alarm may increase as the vicinity to the emergency situation increases and conversely the tone/pitch and/or the frequency of modulation of an audible indication produced at each alarm may decrease as the vicinity to the emergency situation decreases. For example, higher tones/pitches and/or faster frequencies of modulation indicate danger, such that a person seeking escape from the emergency situation would naturally move towards a calmer sound, with a lower tone/pitch and/or a slower frequency of modulation.

When the emergency alarm system comprises more than one electronic alarm, the viable route to an exit may be determined in response to environmental data, such as a relative topology of the alarms in the emergency alarm system. In addition, the viable route to the exit may be updated when the relative topology of the alarms in the emergency alarm system is changed, for example when an alarm is added to and/or removed from the emergency alarm system.

FIG. 2 illustrates schematically an emergency alarm system comprising a plurality of emergency alarms A, B, C, D. The emergency alarms A, B, C, D may be provided on one floor of a building. Alarm A is provided in close proximity to an exit. According to one embodiment, each of the alarms A to D may produce a different audible indication from the audible indication produced by the other alarms. The audible indication produced by each alarm is dependent on the distance between the alarm and the exit, and the number of alarms between the alarm and the exit, such that during an emergency situation a person within the building is able to listen to the audible indications/see the visual indications produced by each alarm and determine a direction of travel to the exit. The distance between the alarm and the exit may be the geographical distance (in terms of the actual distance a person is required to travel when moving between the two alarms, or in terms of “as the crow flies”), network distance, signal strength etc.

According to one embodiment, the frequency of modulation of the audible indication produced by an alarm may increase as the distance between the alarm and the exit decreases. For example, the alarm A may produce an audible indication having a higher frequency of modulation than that produced by the alarms B, C and D, which are all further away from the exit than alarm A. The alarm B may produce an audible indication having a higher frequency of modulation than that produced by the alarms C and D which are further away from the exit than alarm B, and the alarm B may produce an audible indication having a lower frequency of modulation than that produced by the alarm A which is nearer to the exit than alarm B. The alarm C may produce an audible indication having a higher frequency of modulation than that produced by the alarm D which is further away from the exit than the alarm C, and the alarm C may produce an audible indication having a lower frequency of modulation than that produced by the alarms A and B which are nearer to the exit than alarm C. The alarm D may produce an audible indication having a lower frequency of modulation than that produced by the alarms A, B and C which are all nearer to the exit than alarm D.

Conversely, the frequency of modulation of the audible indication produced by an alarm may decrease as the distance between the alarm and the exit decreases. Consequently, during an emergency situation, a person within the building is able to sense the different audible indications being produced by the different alarms and determine a direction of travel to an exit.

According to another embodiment, the pitch of the audible indication produced by an alarm may increases as the distance between the alarm and the exit decreases. For example, the alarm A may produce an audible indication having a higher pitch than that produced by the alarms B, C and D, which are all further away from the exit than alarm A. The alarm B may produce an audible indication having a higher pitch than that produced by the alarms C and D, which are further away from the exit than alarm B, and the alarm B may produce an audible indication having a lower pitch than the alarm A which is nearer to the exit than alarm B. The alarm C may produce an audible indication having a higher pitch than that produced by the alarm D, which is further away from the exit than alarm C, and the alarm C may produce an audible indication having a lower pitch than the alarms A and B which are nearer to the exit than alarm C. The alarm D may produce an audible indication having a lower pitch than that produced by the alarms A, B and C which are all nearer to the exit than alarm D.

Conversely, the pitch of the audible indication produced by an alarm may decrease as the distance between the alarm and the exit decreases. Consequently, during an emergency situation, a person within the building is able to sense the different audible indications being produced by the different alarms and determine a direction of travel to the exit.

Alternatively, or in addition, each alarm may be configured to emit their alarm indication in accordance with a predetermined sequence to indicate the route to the exit, or the emissions of the alarms may be phased, such that during an emergency situation, a person within the building is able to determine a direction of travel to the exit. For example, alarm D may emit its alarm indication, followed by alarm C, followed by alarm B, followed by alarm A, and the sequence repeated continuously, such that it appears that the alarm indication is traveling in the direction of the exit.

Sequencing the audible indications produced by each alarm, together with varying the audible indications produced by each alarm, may result in an emphasised direction of travel to the exit.

An education campaign would be required in order to train users that an increase/decrease in frequency of modulation/pitch and/or sequence of the audible indication indicates that the user is getting nearer to/moving further away from an exit.

Alternatively, or in addition, each alarm may produce a visual indication, which, when activated, work together to indicate a route to an exit. For example, yellow light may indicate that the person is travelling towards the fire, whilst blue light may indicate the person is travelling away from the fire/towards an exit.

An alarm may produce both the audible indication and the visual indication, or different alarms may be used, one generating the audible indication and one generating the visual indication. An alarm system emitting both an audible indication and a visual indication increases the chance of an activated alarm being detected by both hearing impaired and visually impaired people.

With reference to FIG. 2, each alarm may produce a different coloured visual indication from the visual indication produced by the other alarms. The visual indication produced by each alarm is dependent on the distance the alarm is from the exit, such that during an emergency situation a person within the building is able to see the visual indications and determine a direction of travel to the exit.

According to one embodiment, the alarm A which is closest to the exit may produce a blue visual indication, and the alarm D which is furthest from the exit may produce a yellow visual indication. As with the audible indications, an education campaign would be required in order to train users that a blue visual indication indicates that the user is getting nearer to an exit, and a yellow visual indication indicates that the user is getting further away from an exit. It may be advantageous to avoid using the colours red and green as the visual indication, since these are the colours people with colour blindness are not able to detect.

According to another embodiment, the visual indication may be a representation (i.e. text or image) of a distance to and/or a direction of an exit. For example, alarm A which is closest to the exit may produce a visual indication such as “2 meters to exit”, and the alarm D which is furthest from the exit may produce a visual indication such as “20 meters to exit”. The representation may be used in addition to the different colours described above to further emphasise the direction of the exit.

Alternatively, or in addition, the visual indications produced by each alarm may be initiated in a sequence or may be phased, such that during an emergency situation, a person within the building is able to sense the sequence of visual indications being produced by the different alarms and determine a direction of travel to the exit. For example, alarm D may be triggered, followed by alarm C, followed by alarm B, followed by alarm A, and the sequence repeated continuously, such that it appears that the visual indication is traveling in the direction of the exit.

Sequencing the visual indications produced by each alarm may help to emphasise a direction of travel to the exit.

Each alarm may be capable of generating an audible indication at any of the required frequencies of modulation or pitch. Alternatively, or in addition, each alarm may be capable of generating a visual indication in any of the required colours.

When the emergency alarm system comprises a plurality of alarms, each alarm, when activated, produces an alarm indication (audible and/or visual) based on its position within the route to an exit. Each alarm may emit an alarm indication which is different from the alarm indication emitted at other nearby alarms. The alarm indication emitted by each alarm may be modified as a result of the alarms position within the route to an exit.

The pitch or frequency of modulation of an audible indication and/or the visual indication produced by each alarm may be defined by an alarm level. An alarm level may be assigned to an alarm based on its position within a route to an exit. In addition, the alarm level may define the alarms position in a sequence (both audible and/or visual) on a route to an exit. For example, the alarms illustrated in FIG. 2 may have the following alarm levels:

| ALARM | ALARM LEVEL |
|---|---|
| A | 0 |
| B | 1 |
| C | 2 |
| D | 3 |

The alarm level associated with each alarm may be set when a route to the exit is determined. In addition, when a route to the exit is re-determined, for example when a new alarm is added to an alarm system, then an alarm level may be assigned to the new alarm based on its position on the route to the exit, and the alarm level assigned to the existing alarms on the route to the exit may be adjusted. FIG. 3A illustrates schematically the same emergency alarm system as FIG. 2, but with an additional alarm, alarm M. When alarm M was added to the alarm system, the alarm level, defining the audible indication/visual indication the alarm is required to produce when activated, was set. Since alarm M is closer to the exit than alarm D, the alarm M has been assigned alarm level 3, and alarm D has been assigned as new alarm level, alarm level 4. The same principle applies when an alarm is removed from the system. When an alarm is removed from an alarm system, then an alarm level assigned to the remaining alarms on the route to the exit may be altered. FIG. 3B illustrates schematically the same emergency alarm system as FIG. 2, but with alarm B removed. When alarm B was removed from the system, the alarm level of alarm C was altered to alarm level 1, and the alarm level of alarm D was altered to alarm level 2.

The/each exit alarm is assigned the lowest alarm level (i.e. alarm level 0). Thus, any alarm associated with an alarm level 0 may be determined to be an exit node. According to one embodiment a user/installer is required to indicate which alarm(s) is an exit alarm. An exit alarm is the alarm provided closest to an exit. Although the/each exit alarm may be assigned the highest alarm level to indicate that it is an exit alarm, since alarms may be added and removed from the system, the highest number may change which could lead to confusion as to which alarm is the exit alarm.

In addition to, or in the absence of, at least one exit alarm, a refuge alarm may be indicated. A refuge alarm indicates a refuge area/safe area for people who are unable to exit the building, for example disabled people who cannot climb/descend stairs, to wait for rescue. A refuge area is usually equipped with heavy fireproof doors, independent ventilation, and an intercom, such that when a person reaches the refuge area, they can use the intercom to indicate they are there and then they can wait for rescue from the emergency services in a relatively safe place.

When determining a route to a refuge alarm, the same method may be used as determining a route to an exit alarm. In general, an exit alarm may be considered a “safe place” alarm and consequently, to the system/user planning the exit routes the exit alarms and refuge alarms are both considered the end of the route. Therefore, the description herein of determining routes to an exit alarm also applies to determining routes to refuge alarms/refuge areas.

A refuge alarm may be associated with a different alarm level to that of an exit alarm, for example a refuge alarm may be associated with an alarm level 0*. In addition, the refuge alarm level may be associated with a special audible and/or visual indication so that an escapee can distinguish between a route to an exit and a route to a refuge area.

FIG. 4 illustrates a flow diagram of a method of activating emergency alarms. As illustrated in FIG. 4, the process starts at step S201. At step S202, a route to the exit is determined. The topology of the area for which the route to the exit is to be determined may be considered environmental data and may be utilised when determining the route to the exit. For example, a map of the area, indicating the geographical topology of the area, such as the position of obstacles, for example walls, doors etc. may be utilised. Depending on the configuration of the area for which the route to the exit is to be determined, there may be more than one route to the exit, with at least one alarm provided on each route.

Therefore, at step S202, more than one route to the exit may be determined, as required. At step S203, the indication which each alarm is required to produce when activated is set. The emergency alarm system may then be in “sleep mode” until an emergency situation signal is received at the emergency alarm system, at step S204. Following receipt of an emergency situation signal at step S204, the at least one alarm is activated at step S205. The alarm(s) will continue to be active until the system is stopped, at step S206.

An emergency alarm system may be considered to be a network, and each alarm may be considered to be a node within the network. The route from each node to an exit/refuge area, and thus the alarm indication to be generated at each node, may be determined and set at each node by a user, when the emergency alarm system is installed, and whenever a node is added to, or removed from the network.

When the nodes are connected via a wireless mesh network, and at least one exit node/refuge node is identified, then the nodes within the network may automatically determine exit routes, and each node may determine its own alarm indication based on the number of hops it is from the exit node/refuge node on the exit route. An exit node may be any one of the plurality of nodes provided closest to an exit and a refuge node may be any one of the plurality of nodes provided closest to a refuge area.

Each node may be considered an independent unit having a view of the entire network or may only have a view of the nodes within its communication range. Each node is capable of performing wireless communication other network elements. Each node within the network is able to detect all the other nodes within its communication range. In addition, each node is able to determine which of the nodes within its communication range is its nearest neighbour(s). The node may be nearest in terms of geographical distance, network distance, signal strength etc.

According to one embodiment, the alarm system may determine a route to the exit. A route request may be propagated from the exit node to the other nodes of the network. The exit node broadcasts a route request to its nearest neighbour, the closest node of the network with which it is able to communicate. For example, with reference to FIG. 2, nodes B and C are both within communication range of node A. However, node B is closest to node A, therefore, exit node A sends a route request to node B. An exit route link is created between nodes A and B, such that node B forms part of the exit route to node A. Node B then broadcasts the route request to its nearest neighbour. Nodes A, C and D are all within range of node B. However, since node B received a route request from node A it does not to send a route request to node A. In addition, node C is closest to node B. Node B therefore sends a route request to node C. An exit route link is created between nodes B and C, such that node C forms part of the exit route to node A. Node C then broadcasts the route request to its nearest neighbour. Nodes A, B and D are all within range of node C. However, since node C received a route request from node B it does not send a route request to node B. Node D is closest to node C, therefore, node C sends a route request to node D. An exit route link is created between nodes C and D, such that node D forms part of the exit route to node A. Route requests propagate through the network to determine exit routes, such that each node within the network forms part of an exit route.

The network automatically determines a route to the exit node A, the route being node D to node C, to node B, to exit node A. Once a route to the exit node has been determined or following determination of each nodes position on an exit route, each nodes alarm indication may be modified based on its position on the route. According to one embodiment, each node on the route to the exit may be assigned an alarm level based on its position on the route. For example, node A is the exit node and therefore is assigned alarm level 0, node B is the first hop on the route and therefore is assigned alarm level 1, node C is the second hop on the route and therefore is assigned alarm level 2 and node D is the third hop on the route and therefore is assigned alarm level 3.

It is possible for each node to determine its own alarm level based on its position in an exit route. For example, with reference to FIG. 2, a route request starts at the exit node, node A. Each exit node is assigned alarm level 0 as it is the end of an exit route. Following propagation of the route request to node B, node B determines that it should be assigned alarm level 1, since it is the next hop, from node A, on the exit route to node A, node A being assigned alarm level 0. Following propagation of the route request to node C, node C determines that it should be assigned alarm level 2, since it is the next hop, from node B, on the exit route to node A, node B being assigned alarm level 1. Following propagation of the route request to node D, node D determines that it should be assigned alarm level 3, since it is the next hop, from node C, on the exit route to node A, node C being assigned alarm level 2.

It is also possible to use the wireless mesh network to automatically re-determine the route from each node to the exit whenever nodes are added to/removed from the network. Each route determination starts with the exit node, as discussed above, and route requests are propagated throughout the network. Each node may constantly, or periodically, “ping” its neighbours. When nodes are added to/removed from the network these changes are detected and the route to the exits re-determined by propagating route requests.

The automatically determined routes to an exit may be approved by a user, if required. In addition, a user may alter the automatically determined routes, if required.

FIG. 5 illustrates a flow diagram of a method of automatically determining a route to an exit. The process illustrated in FIG. 5 may be performed at step S202 of the process illustrated in FIG. 4, when the nodes of the network determine the exit route(s). At step S301 an exit alarm is identified. An exit alarm is any alarm which is provided closest to the exit, when compared to the other alarms of the system. The exit alarm may be identified by a user. At step S302, the exit alarm broadcasts a route request. The route request may be detected by any of the alarms which are within communication range of with the exit alarm. A first alarm of the plurality of alarms, which is capable of communication with the exit alarm and is closest to the exit alarm is identified and an exit route link is created between the exit alarm and the first alarm, such that the first alarm forms part of the exit route to the exit alarm, at step S303. The first alarm may be closest to the exit alarm in terms of signal strength, geographical distance etc. In addition, the first alarm may not be a prohibited alarm. A prohibited alarm is an alarm that the alarm which is broadcasting the route request may not form an exit route, for example, a prohibited alarm may be closest to the exit alarm in terms of signal strength or geographical distance, but may be provided on a different floor of the building, or separated by a wall etc.

At step S304, the first alarm broadcasts a route request. The route request may be detected by any of the alarms which are within communication range of the first alarm. A second alarm of the plurality of alarms, which is capable of communication with the first alarm and is closest to the first alarm is identified and an exit route link is created between the first alarm and the second alarm, such that the second alarm forms part of the exit route to the exit alarm, at step S305. The second alarm may be closest to the first alarm in terms of signal strength, geographical distance etc. In addition, the second alarm may not be a prohibited alarm or an alarm which already forms part of the exit route to the exit alarm (i.e. may not be the exit alarm).

At step S306, the second alarm broadcasts a route request. The route request may be detected by any of the alarms which are within communication range of the second alarm. A third alarm of the plurality of alarms, which is capable of communication with the second alarm and is closest to the second alarm is identified and an exit route link is created between the second alarm and the third alarm, such that the third alarm forms part of the exit route to the exit alarm, at step S307. The third alarm may be closest to the second alarm in terms of signal strength, geographical distance etc. In addition, the third alarm may not be a prohibited alarm or an alarm which already forms part of the exit route to the exit alarm (i.e. may not be the exit alarm or first alarm).

At step S308, the third alarm broadcasts a route request. The route request may be detected by any of the alarms which are within communication range of the third alarm. A fourth alarm of the plurality of alarms, which is capable of communication with the third alarm and is closest to the third alarm is identified and an exit route link is created between the third alarm and the fourth alarm, such that the fourth alarm forms part of the exit route to the exit alarm, at step S309. The fourth alarm may be closest to the third alarm in terms of signal strength, geographical distance etc. In addition, the fourth alarm may not be a prohibited alarm or an alarm which already forms part of the exit route to the exit alarm (i.e. may not be the exit alarm, first alarm, second alarm).

Following determination of the exit route, the process continues as illustrated on FIG. 4, and the alarm indication to be produced by each of the plurality of alarms which form part of the exit route is modified, in accordance with each of the plurality of alarms position on the route to the exit.

Information regarding the topology of the building/area (network topology and/or geographical topology) from which the exit route is to be determined may be required by the network when determining the exit route(s). For example, the position of obstacles, such as walls, doors etc. may be provided to the network. The topology of the building/area may also define hops which are not allowed for the purposes of exit routes. For example, a first node may detect several nodes within its communication range. However, one of the detected nodes, a second node, may in fact be separated from the first node by a wall/ceiling/floor. Therefore, the topology defines that the first node may not form an exit route link with the second node, the second node is a prohibited node of the first node, and vice versa, such that an exit route link between the first node and the second node is impermissible. According to one embodiment, the network topology may define which nodes each node is allowed/not allowed to form an exit route with, thereby preventing the nodes from establishing an exit route link with the predefined prohibited nodes, such as nodes on different floors within a building, nodes on opposite sides of walls within a building etc.

According to another embodiment, a central server may be used to determine exit routes, and then distributes the route(s) to the nodes of the network, informing each node of its alarm level. The central server may store a network map as well as a layout map of the building/area for which the exit routes are to be determined for use when determining exit routes. Furthermore, the central server may alter the exit routes when nodes are added to/removed from the network.

As stated above, each node is in contact with its neighbours, either constantly, or periodically, “pinging” them to check the status of its neighbours, and thus the viability of each exit route. When a node goes offline and is no longer contactable, then the exit route should be re-determined to take into account the removal of the non-contactable node from the route. In addition, an alarm coordinator should be contacted whenever a node goes offline. The node which determined that its neighbouring node is offline informs the alarm coordinator. The alarm coordinator may be a person or a central computer. A node going offline indicates that there is an issue with the node, for example the node may have a low battery, and therefore the alarm coordinator can investigate and arrange for a new battery to be fitted or maintenance work to be performed etc.

FIG. 6 illustrates schematically an emergency alarm system comprising a plurality of emergency alarms. The emergency alarms may be provided on one floor of a building. In contrast to FIG. 2, FIG. 6 has two exits. Therefore, an exit route has been determined to exit node A, and another exit route has been determined to exit node H. Some of the nodes of the system indicate the exit route to exit node A, whilst some of the nodes of the system indicate the exit route to exit node H. The exit routes may be pre-programmed by a user when the emergency alarm system is installed, and whenever a node is added to, or removed from the network. Alternatively, the exit routes may be automatically determined by the nodes of the network. Automatically determined exit routes may be confirmed and/or altered by a user, if required. Alternatively, the exit routes may be determined at a central server and distributed to the nodes of the network.

As can be seen from FIG. 6, node H is an exit node and is assigned alarm level 0, node G is the first hop on the route to exit node H and is assigned alarm level 1, node F is the second hop on the route to exit node H and is assigned alarm level 2 and node E is the third hop on the route to exit node H and is assigned alarm level 3. In addition, node A is an exit node and is assigned alarm level 0, node B is the first hop on the route to exit node A and is assigned alarm level 1, node C is the second hop on the route to exit node A and is assigned alarm level 2 and node D is the third hop on the route to exit node A and is assigned alarm level 3.

Nodes D and E are both at the end of an exit route, and both are set at alarm level 3. When automatically determining an exit route, both nodes D and E are within communication range of each other and therefore would identify the other node as one of its neighbours. However, since both nodes D and E are set to alarm level 3, each node determines that it would be detrimental to form an exit route link with the other node. If node D linked to node E and formed part of the exit route to node H, then the alarm level of node D would increase to alarm level 4, indicating that the distance to the exit has increased. In addition, if node E linked to node D and formed part of the exit route to node A, then the alarm level of node E would increase to alarm level 4, indicating that the distance to the exit has increased. Consequently, although nodes D and E are within communication range (indicated by the dotted line in FIG. 6) a link is not formed between nodes D and E.

FIG. 7 illustrates schematically an emergency alarm system comprising a plurality of emergency alarms. The emergency alarms may be provided on one floor of a building. FIG. 7 is similar to FIG. 6, but has an additional alarm M. Node M is provided between nodes D and E, and is within communication range of both nodes D and E. When determining a route to an exit, node M could be configured to form part of the route to exit node A or to exit node H, both nodes D and E being set at alarm level 3. When presented with such a scenario, an arbitrary decision may be taken, such that node M is connected to one of the exit routes. According to FIG. 7, node M forms part of the exit route to node H and is set at alarm level 4. However, equally, node M could form part of the exit route to node A and would also be set at alarm level 4. The decision is arbitrary in that, during an emergency situation, a person in the vicinity of node M, which is generating an alarm level 4 indication, is likely to also be able to see/hear the alarm indications generated by nodes D and E, which are both set at alarm level 3. Therefore, a person may follow either route in order to reach an exit.

Although it may appear from FIG. 7, that alarm M is closer to node F than to node E, the network topology may define that node M may not connect directly to node F, for example, because of a wall between the two nodes.

The emergency alarm system may also comprise sensors, such as smoke detectors, heat sensors etc. These sensors may be provided as part of the network. The sensors may be integrated with the alarms or may be provided as separate components.

When an emergency situation is detected, for example, by a smoke alarm detecting smoke, a heat detector detecting heat, a user activating a manual alarm button etc., an emergency situation signal is sent to the alarms of the emergency alarm system, activating the alarms. Prior to receiving an emergency situation signal, the alarms of the emergency alarm system may be in sleep mode. When activated, each emergency alarm of the network projects an alarm indication in accordance with their predefined alarm level. A person within the building is then able to determine a route to an exit by detecting the different alarm indications and thus determining the route to the exit.

With reference to FIG. 6, when a user is at a location between nodes B and C, and the alarms are activated, then the user would know to travel towards node B as a result of the alarm indications provided by the alarms B and C. For example, the audible indication produced by alarm B may have a lower pitch than the audible indication produced by alarm C, indicating to the user that they should move towards alarm B. Furthermore, when a user is at a location between nodes G and H, and the alarms are activated, then the user would know to travel towards node H as a result of the alarm indications provided by the alarms G and H. For example, the audible indication produced by alarm H may have a lower pitch than the audible indication produced by alarm G, indicating to the user that they should move towards alarm H.

When a user is at a location between nodes D and E, and the alarms are activated, then the user would know that they could travel either towards node D or towards nodes E. Both the alarms D and E are set at alarm level 3, and so generate the same alarm indication. For example, both the alarms D and E generate the same pitch of audible alarm.

As stated above, an education campaign would be required in order to train users that an increase/decrease in frequency of modulation/pitch and/or sequence of the audible indication indicates that the user is getting nearer to/moving further away from an exit.

The position of the emergency situation, such as a fire, may be known from the sensor data. For example, when smoke is detected at a smoke alarm, or when a hot spot is detected by a heat sensor, which triggers the alarm system, then it is inferred that a fire (emergency situation) is at a location close to the smoke detector/heat sensor. In addition or alternatively, the location of the emergency situation may be input to the alarm system by a user. When the location of the emergency situation is known or inferred, this environmental data may be used such that the route(s) to an exit may be recalculated and the alarm indication emitted by each of the nodes of the system updated in order to avoid the emergency situation. The routes to an exit may be recalculated upon receipt of an instruction to recalculate, and/or automatically in response to the location of an emergency situation being known. Only the route effected by the emergency situation may be recalculated. For example, when an emergency situation is located on a first floor of a building only the routes on the first floor may be recalculated. The routes on the other floor(s) of the building may not be recalculated, unless the route is affected by the location of the emergency situation.

FIG. 8 illustrates schematically an emergency alarm system comprising a plurality of emergency alarms. The emergency alarms may be provided on one floor of a building. FIG. 8 is similar to FIG. 6, but illustrates a fire detected between nodes B and C. The exit routes described above, with reference to FIG. 6, may be reconfigured as a result of the detected fire. According to one embodiment, when the nodes are connected via a wireless mesh network, the nodes within the network may automatically reconfigure the exit route(s) when the location of an emergency situation is known.

As can be seen from FIG. 8, a fire is detected between nodes B and C. As a result of the fire being detected between nodes B and C, it is no longer considered safe for a person to travel between nodes B and C and the link between nodes B and C is broken. The exit route link between nodes B and C may be broken by being considered a prohibited link, such that node B is no longer permitted to connect to node C and node C is no longer permitted to connect to node B. Node C is no longer considered a nearest neighbour of node B, and vice versa. Since the link between nodes B and C is considered a prohibited link, the exit routes are re-determined. A link between nodes may also be considered broken when a node is no longer active, for example, when a node goes off-line, possibly as a result of damaged due to the emergency situation, and the exit routes are re-determined.

According to one embodiment, each node may be constantly, or periodically, checking its links to its nearest neighbour(s). When a link between two nodes is broken, the nodes search for a new nearest neighbour, in order to complete an exit route. With reference to FIG. 8, when the link between nodes B and C is broken, nodes C and D no longer part form part of the exit route to node A. In addition, nodes C and D no longer form part of any exit route. Therefore, nodes C and D broadcast that they are no longer part of an exit route.

Node D is within range of node E. Upon receipt of the message that node D is no longer part of an exit route, node E sends a route request to node D. Node D then sends a route request to node C. Nodes C and D form part of the exit route to node H and are assigned an alarm level based on their position within the route. For example, node D is the fourth hop on the route and therefore is assigned alarm level 4, and node C is the fifth hop on the route and therefore is assigned alarm level 5.

A person positioned between nodes B and C would now see/hear two different alarm indications, an alarm level 1 emitted by node B and an alarm level 5 emitted by node C. It is considered that a person would not move towards node B, which is emitting an alarm level 1, suggestive of a close proximity to an exit, when the fire is positioned between the person and node B, since the person would be able to see/feel the fire and therefore would move in the opposite direction, towards node C. However, in some circumstances, such as when an emergency situation is in very close proximity to a node, it may be preferable to prevent a node from emitting an alarm indication to prevent people moving towards that node. In such circumstances, node B may be deactivated.

FIG. 9 illustrates schematically an emergency alarm system comprising a plurality of emergency alarms. The emergency alarms may be provided on one floor of a building. FIG. 9 is similar to FIG. 6, but illustrates a fire detected in close proximity to node A, the exit node. Since the fire is detected in close proximity to the exit, exit node A may no longer be considered a viable exit and the exit routes are reconfigured. Node A may broadcast a signal indicating that it is no longer considered an exit node, and/or the link between nodes A and B may be broken. For example, node A and/or node B may broadcast a signal indicating that the link between nodes A and B is a prohibited link.

Alternatively, node A may go off line, for example, node A may be deactivated as a result of the detection of the fire, or node A may fail as a result of the fire. When an exit node is no longer active, another exit node may be identified and an exit route(s) to that exit node may be determined. Another exit node be identified, by virtue of there already being more than one exit node, as illustrated in FIGS. 6 to 10.

Nodes B, C and D no longer form part of an exit route. Therefore, nodes B, C and D broadcast that they are no longer part of an exit route, and a route to an exit is re-determined.

Node D is within range of node E. Upon receipt of the message that node D is no longer part of an exit route, node E sends a route request to node D. Node D sends a route request to node C, and node C sends a route request to node B. Nodes B, C and D form part of the exit route to node H and are assigned an alarm level based on their position within the route. For example, node D is the fourth hop on the route and therefore is assigned alarm level 4, node C is the fifth hop on the route and therefore is assigned alarm level 5, and node B is the sixth hop on the route and therefore is assigned alarm level 6.

A person positioned between nodes A and B may now see/hear two different alarm indications, an alarm level 0 emitted by node A (if still active) and an alarm level 6 emitted by node B. It is considered that a person positioned between nodes A and B would not move towards node A, which is emitting an alarm level 0, suggestive of a close proximity to an exit, when the fire is between the person and node A, since the person would be able to see/feel the fire and therefore the person would move in the opposite direction, towards node B. However, in some circumstances, such as when the fire is in very close proximity to node A, such that the exit is blocked, it may be preferable to prevent node A from emitting an alarm indication to prevent people moving towards node A, when the exit is blocked. In such circumstances, node A may be deactivated.

Alternatively, or in addition to each node constantly, or periodically, checking its links to its nearest neighbour(s), nodes may broadcast when a link has been broken, when a node is no longer to be considered an exit node/refuge node, and/or when a node to which it was previously in communication with is no longer active and has gone offline. The exit routes may then be reconfigured, if required. In addition, the exit routes may be reconfigured when an emergency situation is detected by a sensor.

When the alarm indication comprises an audible indication informing people within the building of a distance to and/or a direction to the exit, this message may be altered as a result of the reconfigured route. When the alarm indication comprises a visual indication informing people within the building of a distance to and/or a direction to the exit, this message may be altered as a result of the reconfigured route.

As stated above, each node is in contact with its neighbours, either constantly, or periodically, “pinging” them to check the status of its neighbour's. When a node goes offline, or a route is no longer viable, for example, because the link between two nodes is broken, or an emergency situation is determined to be on that route, then a route is re-evaluated. When determining a neighbour nodes status, the nodes may also enquire as to the neighbour nodes alarm level. It is then possible for a node to set its own alarm level by virtue of knowing its neighbours alarm level. When a neighbour node is alarm level 2, then a node connecting to the exit route sets its own alarm level to alarm level 3.

Each node may store, dependent on the capabilities of the node and the requirements of the network, all the exit routes of the network to which it belongs, exit route information from that node to the exit, or only the next hop in an exit route from itself.

A central server may be used to reconfigure the exit routes, when an emergency situation is detected, and then distribute the reconfigured route to the nodes of the network, informing each node of its alarm level. According to another embodiment, a node may query a central server, with regards to an exit route, when it is determined that a link is no longer permitted, a node is no longer an exit node, a node has gone offline, an emergency situation is detected etc. According to another embodiment, alternative routes to an exit may be predetermined by a user and preprogramed into the network, such that when an emergency situation is detected and/or one or more of the nodes go offline, the routes are reconfigured in accordance with the preprogramed routes.

According to one embodiment, if no acceptable route to an exit can be determined, then the alarm coordinator should be contacted. The alarm coordinator may then either:

1. manually create a “least bad” exit route, for example, by manually changing the status of a prohibited node or link in the topology, or by adding a new node to the network; or

2. designate one of the nodes as a refuge node.

Nodes may be designated in advance as refuge nodes such that if during an emergency situation no viable route to an exit may be determined, for example in case of isolation, then a person may be directed to a refuge area instead.

The geographical distance between two nodes may be determined based on the signal strength detected between the nodes. Alternatively or in addition, the geographical distance between two nodes may be determined based on a layout map of the building/area (a geographical topology of the building/area) for which the exit routes are to be determined. It may then be possible to optimise each exit route, such that each route provides the shortest route to the exit. For example, FIG. 10 illustrates the same layout as FIG. 6. However, the geographical distance a person is required to travel along a route from node D to node H, via nodes E, F and G is in fact equivalent to the geographical distance a person is required to travel along a route from node C to node A. Therefore, the routes to exit nodes A and H have been amended, when compared to the routes of FIG. 6, to take into account the geographical distance between the nodes. The routes may be altered by a user, following determination of the routes. According to another embodiment, each node in the network is provided with the geographical distance between itself and other nodes in the network, and/or the geographical distance between all the nodes in the network, such that the wireless mesh network determines the route from each node to the exit optimising each route in accordance with the geographical distance between the nodes.

FIGS. 2, 3A, 3B and 6 to 10 may be considered to illustrate an arrangement of a plurality of emergency alarms provided on one floor of a building. However, exit routes from a building may cover more than one floor of a building. For example, an exit route may guide a user to an exit from the floor, and then guide the user down stairs to an exit from the building. Such an exit route would be configured as described above.

It is well known that users often carry IoT (Internet of Things) devices, such as Smart watches, Smart phones, tablets etc. According to one embodiment, an users personal IoT device may connect to the emergency alarm system network, when the device is within the area for which an exit route has been determined. The users device may connect to the emergency alarm system wirelessly using the WiFi™ network etc. The users device may then receive alarm indications, the received alarm indication being the same as the alarm indication of the node to which the user is in closest proximity. FIG. 11A illustrates the same layout as FIG. 8, but a user 100 is also illustrated. The user 100 is in close proximity to alarm E. Therefore, the users device will receive an alarm indication the same as that of alarm E, in this example, alarm level: 3. When an emergency situation is detected and the emergency alarm system activated, the users device will also be activated to emit the alarm indication of is closest alarm. As the user moves along the route to the exit, the alarm indication emitted by the users device may change to indicate the route to the exit. For example, FIG. 11B illustrates the same layout as FIG. 11A, but the user 100 has moved towards the exit. In FIG. 11B the users device would now be emitting an alarm indication of alarm level 2, similar to the alarm F, the closest alarm.

Alternatively, the type of alarm indication emitted by the users device may not be the same as that emitted by the alarms. The users device may emit an alarm indication determined in response to an users preferences. For example, the user may be deaf, therefore, although the alarms may emit an audible alarm indication, the users device may emit an alarm indication determined in response to the users preferences, i.e. a visual alarm indication. Although the type of indication may be different, the level of alarm indication is the same, so that the user may be directed along the exit route to the exit.

According to a further embodiment, the network may specify different routes for different classes of user. For example, users with reduced mobility may be directed away from stairs using an alternative exit route or may be directed to a refuge area instead. The system assigns different “costs” to each link in the route depending on the class of user, which may result in different optimal routes for different users. In this case, the users device defines the users preference as a class of user and the alarm indication and alarm level emitted on the user's personal device may differ from the general alarms, such that the user is guided along a different exit route or to a refuge area.

FIG. 12 illustrates schematically an emergency alarm 400 for use in the emergency alarm system described herein. The alarm 400 comprises a communications module 410 for communicating wirelessly with one or more of the plurality of alarms of the emergency alarm system within its communication range and for communicating wirelessly with a central sever. The communication module 410 is also configured to receive an emergency situation signal indicative of an emergency situation. The communication module 410 may use wireless communication such as WiFi™, Zigbee™, Bluetooth™, 6LoWPAN etc., short range communication such as radio frequency communication (RFID) or near field communication (NFC), or a cellular network, such as 3G, 4G, 5G.

The alarm 400 also comprises a storage module 420 configured to store environmental data, such as a relative topology of a plurality of emergency alarms of the emergency alarm system. The relative topology of a plurality of emergency alarms may comprises all of the alarms of the emergency alarm system, or only the alarms of emergency alarm system that the alarm 400 is able to communicate with.

The storage module 420 may also store environmental data, such as a topology of an area for which the viable route to the exit is determined. For example, geographical data defining the position of obstacles, such as walls, doors etc. The storage module 420 may be configured to communicate with at least one processing module 430.

The processing module 430 may use the stored relative topology of the plurality of emergency alarms, to determine if one or more of its neighbour alarms has gone off-line, or if one or more alarms have been added to the system/moved to within its communication range. The processing module 430 may inform a central sever via the communications module 410 when a neighbour alarm has gone off-line.,

Memory 440 may store computer program code to implement the methods described herein. The processing module 430 may comprise processing logic to process data and generate output signals in response to the processing, such as determining and re-determining the viable route to the exit in response to the environmental data, and modifying the indication to be emitted by the emitter 450 in response to a re-determination of the viable route to the exit. The processing module 430 is configured to communicate with the storage module 420, memory 440, the communication module 410, and an emitter 450. When a route to an exit is determined by a central server, the communication module 410 receives the route and the processing module 430 generates output signals to the emitter 450 for emitting the alarm indication.

The emitter 450 may emit an audible indication and/or a visual indication indicating a viable route to an exit, in response to the emergency alarm 400 receiving an emergency situation signal indicative of an emergency situation.

The memory 440 and/or the storage module 420 may comprise a volatile memory such as random access memory (RAM), for use as temporary memory whilst the device 400 is operational. Additionally, or alternatively, the memory 440 and/or the storage module 420 may comprise non-volatile memory such as Flash, read only memory (ROM) or electrically erasable programmable ROM (EEPROM), for storing data, programs, or instructions received or processed by the device 400.

As will be appreciated by one skilled in the art, the present techniques may be embodied as a system, method or computer program product. Accordingly, the present techniques may take the form of an entirely hardware embodiment, an entirely software embodiment, or an embodiment combining software and hardware.

Furthermore, the present techniques may take the form of a computer program product embodied in a computer readable medium having computer readable program code embodied thereon. The computer readable medium may be a computer readable signal medium or a computer readable storage medium. A computer readable medium may be, for example, but is not limited to, an electronic, magnetic, optical, electromagnetic, infrared, or semiconductor system, apparatus, or device, or any suitable combination of the foregoing.

Computer program code for carrying out operations of the present techniques may be written in any combination of one or more programming languages, including object oriented programming languages and conventional procedural programming languages.

For example, program code for carrying out operations of the present techniques may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog™ or VHDL (Very high speed integrated circuit Hardware Description Language).

The program code may execute entirely on each node, partly on each node and partly on a remote server or entirely on the remote server. In the latter scenario, the remote server may be connected to the nodes through any type of network. Code components may be embodied as procedures, methods or the like, and may comprise sub-components which may take the form of instructions or sequences of instructions at any of the levels of abstraction, from the direct machine instructions of a native instruction set to high-level compiled or interpreted language constructs.

It will also be clear to one of skill in the art that all or part of a logical method according to the preferred embodiments of the present techniques may suitably be embodied in a logic apparatus comprising logic elements to perform the steps of the method, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

In one alternative, an embodiment of the present techniques may be realized in the form of a computer implemented method of deploying a service comprising steps of deploying computer program code operable to, when deployed into a computer infrastructure or network and executed thereon, cause said computer system or network to perform all the steps of the method.

In a further alternative, the preferred embodiment of the present techniques may be realized in the form of a data carrier having functional data thereon, said functional data comprising functional computer data structures to, when loaded into a computer system or network and operated upon thereby, enable said computer system to perform all the steps of the method.

It will be clear to one skilled in the art that many improvements and modifications can be made to the foregoing exemplary embodiments without departing from the scope of the present techniques.

As will be appreciated from the foregoing specification, techniques are described providing a method for indicating at least one emergency escape route.

In embodiments, the environmental data comprises a determined relative topology of the plurality of alarms in the emergency alarm system.

In embodiments, the environmental data comprises an indication of a location of the emergency situation.

In embodiments, the environmental data comprises a topology of an area for which the viable route to the exit is determined.

In embodiments, the topology of the area comprises a geographical topology.

In embodiments, in response to a change in the environmental data, re-determining the viable route to the exit and modifying the indication of the plurality of alarms based on the re-determined viable route.

In embodiments, the determined viable route is changed in response to environmental data.

In embodiments, the method further comprises: adjusting the indication produced by each of the plurality of alarms, such that, when activated, the indication produced by one of the plurality of alarms is different from the indication produced by at least one other alarm of the plurality of alarms.

In embodiments, the plurality of alarms are configured to produce an audible indication, and wherein adjusting the indication produced by each of the plurality of alarms comprises adjusting one or more of: a pitch of the audible indication produced by each of the plurality of alarms; a tone of the audible indication produced by each of the plurality of alarms; a frequency of modulation of the audible indication produced by each of the plurality of alarms.

In embodiments, the plurality of alarms are configured to produce a visual indication, and wherein adjusting the indication produced by each of the plurality of alarms comprises adjusting a colour of the visual indication produced by each of the plurality of alarms.

In embodiments, the method further comprises: activating the plurality of alarms to produce their indications in accordance with a predetermined sequence.

In embodiments, wherein each alarm of the plurality of alarms is configured to communicate wirelessly with one or more of the plurality of alarms.

In embodiments, the plurality of alarms are configured to form a mesh network.

In embodiments, the method further comprises: automatically determining the viable route to the exit, wherein a method of automatically determining the viable route to the exit comprises: identifying one of the plurality of alarms as an exit alarm; broadcasting a route request from the exit alarm to a first alarm of the plurality of alarms; creating an exit route link between the exit alarm and the first alarm; broadcasting a route request from the first alarm to a second alarm of the plurality of alarms; creating an exit route link between the first alarm and the second alarm; and modifying the alarm indication to be produced by each of the plurality of alarms which form part of the route to the exit, in accordance with each of the plurality of alarms position on the route to the exit.

In embodiments, the method further comprises: broadcasting a route request from the second alarm to a third alarm of the plurality of alarms; creating an exit route link between the second alarm and the third alarm; broadcasting a route request from the third alarm to a fourth alarm of the plurality of alarms; creating an exit route link between the third alarm and the fourth alarm.

In embodiments, the emergency alarm system further comprises a central server, and wherein the central server determines the route to the exit.

In embodiments, the method further comprises: determining that one or more of the plurality of alarms is no longer active; and re-determining the route to the exit, in response to determining that one or more of the plurality of alarms is no longer active.

In embodiments, the method further comprising: notifying an alarm coordinator that one or more of the plurality of alarms is no longer active.

In embodiments, the method further comprises: determining that the exit alarm is no longer active; identifying another exit alarm; and determining an exit route to the another exit alarm, in response to determining that the exit alarm is no longer active.

In embodiments, the method further comprises: notifying an alarm coordinator that the exit alarm is no longer active.

In embodiments, the method further comprises: determining that one or more of the exit route links is no longer active; and re-determining the route to the exit, in response to determining that one or more of the exit route links is no longer active.

In embodiments, the method further comprises: notifying an alarm coordinator that one or more of the exit route links is no longer active.

In embodiments, the method further comprises: determining that one or more alarms have been added to the emergency alarm system; and re-determining the route to the exit, in response to determining that one or more alarms has been added to the emergency alarm system.

In embodiments, each of the plurality of alarms, which form part of the route to the exit, modify their own alarm indication, in accordance with each of the plurality of alarms position on the route to the exit.

In embodiments, modifying the alarm indication to be produced by each of the plurality of alarms, comprises: assigning each of the plurality of alarms which form part of the route to the exit an alarm level, the alarm level defining the indication to be produced by each of the plurality of alarms.

In embodiments, the emergency situation signal comprises a location of the emergency situation; and the method further comprises: determining whether the location of the emergency situation is on the route to the exit, and when it is determined that the location of the emergency situation is on the route to the exit; re-determining the route to the exit, the re-determined route to the exit leading away from the location of the emergency situation; and modifying the indication produced by the plurality of alarms to indicate the re-determined route to the exit.

In embodiments, the emergency alarm system further comprises at least one danger sensor; and the method further comprises: receiving the emergency situation signal from the at least one danger sensor.

In embodiments, the method further comprises: identifying a user device; activating the user device in response to receiving an emergency situation signal; and wherein, following activation, the user device indicates the route to the exit.

In embodiments, the user device is configured to produce an alarm indication the same as an alarm indication emitted by one of the plurality of alarms proximate to the user device.

In embodiments, the user device is configured to produce an alarm indication different from an alarm indication emitted by one of the plurality of alarms proximate to the user device.

In embodiments, the user device is configured to produce an alarm indication determined in response to an user preference.

In embodiments, the user device is configured to indicate a route to the exit determined in response to the user preferences, and wherein the route to the exit to be indicated on the user device is different from the route to the exit indicated by the at least one alarm.

In embodiments, the route to the exit comprises a route to a refuge area.

In embodiments, the plurality of alarms are configured to produce an audible indication of the route to the exit, following activation.

In embodiments, the plurality of alarms are configured to produce a visual indication of the route to the exit, following activation.

Techniques are also described providing an emergency alarm system for indicating at least one emergency escape route.

In embodiments, the environmental data comprises a determined relative topology of the plurality of alarms in the emergency alarm system.

In embodiments, the environmental data comprises a location of the emergency situation.

In embodiments, the environmental data comprises a topology of an area for which the viable route to the exit is determined.

In embodiments, the topology of the area comprises a geographical topology.

In embodiments, in response to a change in the environmental data, re-determining the viable route to the exit and modifying the indication of the plurality of alarms based on the re-determined viable route.

In embodiments, the determined viable route is changed in response to environmental data.

In embodiments, the indication produced by each of the plurality of alarms is different from the indication produced by other alarms of the plurality of alarms.

In embodiments, the plurality of alarms are configured to produce an audible indication, and wherein one or more of: a pitch of the indication produced by each of the plurality of alarms is different from a pitch of the indication produced by the other alarms of the plurality of alarms; a tone of the indication produced by each of the plurality of alarms is different from a tone of the indication produced by the other alarms of the plurality of alarms; a frequency of modulation of the indication produced by each of the plurality of alarms is different from a frequency of modulation of the indication produced by the other alarms of the plurality of alarms.

In embodiments, the plurality of alarms are configured to produce a visual indication, and wherein a colour of the visual indication produced by each of the plurality of alarms is different from a colour of the visual indication produced the other alarms of the plurality of alarms.

In embodiments, the plurality of alarms are configured to produce their indications in accordance with a predetermined sequence.

In embodiments, the plurality of alarms are configured to determine the route to the exit.

In embodiments, the emergency alarm system further comprises: a central server, and wherein the central server determines the route to the exit.

In embodiments, each of the plurality of alarms, which form part of the route to the exit, is configured to adjust their own alarm indication, in accordance with each of the plurality of alarms position on the route to the exit.

In embodiments, each of the plurality of alarms is configured to adjust their own alarm indication in accordance with an assigned alarm level, the alarm level defining the indication to be produced by each of the plurality of alarms.

In embodiments, the emergency alarm system further comprises: at least one danger sensor, and wherein the emergency situation signal is received from the at least one danger sensor.

In embodiments, the emergency alarm system further comprises: a user device, wherein the user device is configured to be activated in response to receiving the emergency situation signal; and wherein, following activation, the user device indicates the route to the exit.

In embodiments, the user device is configured to produce an alarm indication the same as an alarm indication emitted by one of the plurality of alarms proximate to the user device.

In embodiments, the user device is configured to produce an alarm indication different from an alarm indication emitted by one of the plurality of alarms proximate to the user device.

In embodiments, the user device is configured to produce an alarm indication determined in response to an user preference.

In embodiments, the user device is configured to indicate a route to the exit determined in response to the user preferences, and wherein the route to the exit to be indicated on the user device is different from the route to the exit indicated by the at least one alarm.

In embodiments, the route to the exit comprises a route to a refuge area.

In embodiments, the at least one alarm is configured to produce an audible indication of the route to the exit.

In embodiments, the at least one alarm is configured to produce a visual indication of the route to the exit.

Techniques are also described providing an emergency alarm for use in an emergency alarm system.

In embodiments, the emergency alarm further comprises: a communication module for communicating with one or more emergency alarms of the emergency alarm system; and wherein the processor is further configured to communicate with the one or more emergency alarms of the emergency alarm system to determine the viable route to the exit.

In embodiments, the communication module is configured to receive a location of the emergency situation; and the processor is further configured to communicate with the one or more emergency alarms of the emergency alarm system to re-determine the viable route to the exit.

In embodiments, the emergency alarm further comprises: a storage module for storing a determined relative topology of the one or more emergency alarms of the emergency alarm system.

In embodiments, the processor is further configured to determine that one or more of the emergency alarms of the emergency alarm system is no longer active, and in response to the determination, re-determine the viable route to the exit.

In embodiments, the processor is further configured to notify an alarm coordinator that the one or more of the emergency alarms of the emergency alarm system is no longer active.

In embodiments, the processor is further configured to determine that an exit alarm of the emergency alarm system is no longer active, and in response to the determination, identifying another exit alarm and determine a viable route to the another exit.

In embodiments, the processor is further configured to notify an alarm coordinator that the exit alarm is no longer active.

In embodiments, the processor is further configured to determine that one or more exit route links is no longer active and in response to the determination, re-determine the viable route to the exit.

In embodiments, the processor is further configured to notify an alarm coordinator that the one or more exit route links is no longer active.

In embodiments, the processor is further configured to determine that one or more alarms have been added to the emergency alarm system and in response to the determination, re-determine the viable route to the exit.

In embodiments, the storage module is further configured to store a topology of an area for which the viable route to the exit is determined.

In embodiments, the emergency alarm further comprises: a communication module for receiving the viable route to the exit from a central server.

In embodiments, the processor is further configured to modify the alarm indication to be emitted by the emitter in response to the alarms position on the viable route to the exit.

In embodiments, the processor is further configured to adjust the alarm indication to be emitted by the emitter m, such that, when activated, the indication produced by the emitter is different from the indication produced by other alarms of the emergency alarm system.

1. A method for indicating at least one emergency escape route, the method comprising:
activating, in response to receiving an emergency situation signal indicative of an emergency situation, an emergency alarm system comprising a plurality of electronic alarms; and
wherein, following activation, the plurality of electronic alarms indicate a determined viable route to an exit, the viable route determined based on environmental data.

2. The method of claim 1, further comprising:
automatically determining the viable route to the exit, wherein a method of automatically determining the viable route to the exit comprises:
identifying one of the plurality of alarms as an exit alarm;
broadcasting a route request from the exit alarm to a first alarm of the plurality of alarms;
creating an exit route link between the exit alarm and the first alarm;
broadcasting a route request from the first alarm to a second alarm of the plurality of alarms;
creating an exit route link between the first alarm and the second alarm; and
modifying the alarm indication to be produced by each of the plurality of alarms which form part of the route to the exit, in accordance with each of the plurality of alarms position on the route to the exit.

3. The method of claim 2, further comprising:
broadcasting a route request from the second alarm to a third alarm of the plurality of alarms;
creating an exit route link between the second alarm and the third alarm;
broadcasting a route request from the third alarm to a fourth alarm of the plurality of alarms;
creating an exit route link between the third alarm and the fourth alarm.

4. The method of claim 1, further comprising:
identifying a user device;
activating the user device in response to receiving an emergency situation signal; and
wherein, following activation, the user device indicates the route to the exit.

5. The method of claim 4, wherein the user device is configured to indicate a route to the exit determined in response to an users preferences.

6. The method of claim 5, wherein the route to the exit to be indicated on the user device is different from the route to the exit indicated by the at least one alarm.

7. The method of claim 5, wherein the indication produced by the user device is different from the indication produced by the plurality of alarms.

8. The method of claim 1, wherein the environmental data comprises a determined relative topology of the plurality of alarms in the emergency alarm system.

9. The method of claim 1, wherein the environmental data comprises an indication of a location of the emergency situation.

10. The method of claim 1, wherein the environmental data comprises a topology of an area for which the viable route to the exit is determined.

11. The method of claim 1, wherein in response to a change in the environmental data, re-determining the viable route to the exit and modifying the indication of the plurality of alarms based on the re-determined viable route.

12. The method of claim 1, further comprising:
adjusting the indication produced by each of the plurality of alarms, such that, when activated, the indication produced by one of the plurality of alarms is different from the indication produced by at least one other alarm of the plurality of alarms.

13. The method of claim 12, wherein the plurality of alarms are configured to produce an audible indication, and wherein adjusting the indication produced by each of the plurality of alarms comprises adjusting one or more of: a pitch of the audible indication produced by each of the plurality of alarms; a tone of the audible indication produced by each of the plurality of alarms; a frequency of modulation of the audible indication produced by each of the plurality of alarms.

14. The method of claim 12, wherein the plurality of alarms are configured to produce a visual indication, and wherein adjusting the indication produced by each of the plurality of alarms comprises adjusting a colour of the visual indication produced by each of the plurality of alarms.

15. The method of claim 1, further comprising:
activating the plurality of alarms to produce their indications in accordance with a predetermined sequence.

16. The method of claim 1, wherein each alarm of the plurality of alarms is configured to communicate wirelessly with one or more of the plurality of alarms.

17. The method of claim 16, wherein the plurality of alarms are configured to form a mesh network.

18. The method of claim 1, wherein the emergency alarm system further comprises a central server, and wherein the central server determines the route to the exit.

19. The method of claim 2, further comprising:
determining that one or more of the plurality of alarms is no longer active; and
re-determining the route to the exit, in response to determining that one or more of the plurality of alarms is no longer active.

20. The method of claim 2, further comprising:
determining that the exit alarm is no longer active;
identifying another exit alarm; and
determining an exit route to the another exit alarm, in response to determining that the exit alarm is no longer active.

21. (canceled)

22. (canceled)

23. (canceled)

24. (canceled)

25. (canceled)

26. (canceled)

27. (canceled)

28. (canceled)
